(19) United States
(12) Patent Application Publication
(10) Pub. No.: US 2026/0142536 A1
(43) Pub. Date: May 21, 2026

(54) ECCENTRICITY MEASUREMENT SYSTEM AND METHOD OF MANUFACTURING MOTOR SYSTEM INCLUDING THE SAME

(71) Applicant: HYUNDAI MOBIS CO., LTD., Seoul (KR)

(72) Inventor: Sanghan LEE, Yongin-si (KR)

(73) Assignee: HYUNDAI MOBIS CO., LTD., Seoul (KR)

(21) Appl. No.: 19/392,340

(22) Filed: Nov. 18, 2025

(30) Foreign Application Priority Data
Nov. 21, 2024 (KR) 10-2024-0167072
Nov. 21, 2024 (KR) 10-2024-0167080

(51) Int. Cl. H02K 11/20

(52) U.S. Cl. CPC H02K 11/20

(57) ABSTRACT

The present disclosure relates to an eccentricity measurement system, and more particularly, to an eccentricity measurement system, which is applied to a motor system comprising a stator and a rotor and measures eccentricity of the rotor. The eccentricity measurement system comprises: an eccentricity measurement sensor fitted with a shoe of the stator and configured to measure a presence or absence of eccentricity of the rotor by measuring a change in magnetic field generated between the rotor and the stator, and a sensing terminal configured to transfer sensing information of the eccentricity measurement sensor to an external device, wherein an electrode pattern electrically connected to the eccentricity measurement sensor is inserted into the sensing terminal.

### CROSS REFERENCE TO RELATED APPLICATION

The present application claims priority to Korean Patent Application No. 10-2024-0167072, filed Nov. 21, 2024 and Korean Patent Application No. 10-2024-0167080, filed Nov. 21, 2024, the entire contents of which is incorporated herein for all purposes by this reference.

### BACKGROUND OF THE DISCLOSURE

### Field of the Disclosure

The present disclosure relates to an eccentricity measurement system, and more particularly, to an eccentricity measurement system configured to measure eccentricity occurring in a motor rotor, and a method of manufacturing a motor system including the same.

### Description of the Related Art

Reflective laser displacement sensors are being widely used for methods of measuring rotor eccentricities of permanent magnet electric motors. This method measures variations in distance by irradiating a rotary shaft directly with laser beams. The method has an advantage of being intuitively understandable and applicable to various rotary devices. In addition, transmissive micrometers or transmissive 2D micrometers are also used in industrial sites.

However, in case that an outer diameter of a rotor core other than a shaft is measured when a reflective laser displacement sensor in the related art is applied to a permanent magnet electric motor, a sensor needs to be mounted outside a housing of an electric motor, and a surface of the rotor core needs to be irradiated with laser beams. However, because the rotor core is covered by a stator in the structure of the electric motor, the laser beams cannot penetrate the rotor core, and the measurement cannot be performed. In particular, there is a problem in that it is difficult to measure static eccentricity because it is impossible to measure a radial displacement at a single point.

For this reason, at least two or more sensors are required to be provided on two opposite sides even though a portion of the shaft that is not covered by the stator core. In this case, the sensor may interfere with other external components, which imposes a restriction on a sensor mounting structure and leads to an increase in costs of the system.

### DOCUMENT OF RELATED AR

[Patent Document] Japanese Patent No. 6441757 “Eccentricity Direction Detection Device and Variable Gap Motor”

### SUMMARY OF THE DISCLOSURE

The present disclosure is proposed to solve these problems and aims to provide an eccentricity measurement system including an eccentricity measurement sensor mounted in a motor and configured to measure all tilt eccentricity, static eccentricity, and dynamic eccentricity of a rotor by using a change in magnetic field generated between the rotor and a stator, thereby overcoming a limitation of a reflective laser sensor method in the related art, reducing costs in comparison with the reflective laser sensor in the related art, detecting an eccentricity factor that most significantly affects noise and vibration of a rotary device, detecting a defect at an initial stage of mass production to prevent shipment of potentially defective products, measuring eccentricity caused by abrasion or the like after product durability testing or after prolonged operation of a vehicle to detect in advance a problem, and taking in advance an action such as repair, and a method of manufacturing a motor system including the same.

With the above-described eccentricity measurement system and the method of manufacturing the motor system including the same, when the eccentricity measurement system is applied to autonomous vehicles in the future, it is possible to monitor a mechanical state of a rotary device, apply the eccentricity measurement system to a smart rotary device system capable of evaluating a state thereof by using a pre-secured defect level index, and recognize the state of the rotary device in a region imperceptible to humans. Furthermore, the eccentricity measurement system may be applied in a case in which it is difficult to recognize a state of an individual rotary device because of external vibration or noise, such that the eccentricity measurement system may be used to detect and address problems in an electric motor used in urban air mobility (UAM) aircraft in advance.

In order to achieve the above-mentioned objects, one aspect of the present disclosure provides an eccentricity measurement system, which is applied to a motor system including a stator and a rotor and measures eccentricity of the rotor, the eccentricity measurement system including: an eccentricity measurement sensor fitted with a shoe of the stator and configured to measure the presence or absence of eccentricity of the rotor by measuring a change in magnetic field generated between the rotor and the stator; and a sensing terminal configured to transfer sensing information of the eccentricity measurement sensor to the outside (e.g., an external device), in which an electrode pattern electrically connected to the eccentricity measurement sensor is inserted into the sensing terminal.

In addition, the eccentricity measurement sensor may include: a sensor housing including an insertion hole penetratively formed so that the shoe of the stator is fitted into the insertion hole; a sensor coil wound around the sensor housing, disposed to extend along outer peripheries of a surface of the shoe of the stator and a surface of the rotor facing each other, and configured to measure a change in magnetic field generated between the rotor and the stator; and a pin coupled to the sensor housing, protruding from one surface of the sensor housing, electrically connected to the sensor coil, and configured to transmit a magnetic field signal of the sensor coil to the outside.

In addition, the sensor housing may include a bobbin portion that is a groove concavely formed along the outer peripheries of the surface of the shoe of the stator and the surface of the rotor that face each other, the bobbin portion having one surface that adjoins the sensor coil, one surface of the bobbin portion, which adjoins the sensor coil, may be formed to be round, and the bobbin portion may be formed such that a depth of a center based on a radial direction is deeper than a depth of an outer periphery based on the radial direction.

In addition, the sensor housing may include a protruding portion protruding from the insertion hole toward the shoe of the stator and having a protruding surface that adjoins the shoe of the stator.

In addition, a surface of the protruding portion, which adjoins the stator, may be formed to be inclined at a predetermined angle without being perpendicular or parallel to a circumferential direction.

In addition, the protruding portion may include a sensor depressing groove concavely formed at a position spaced apart inward, at a predetermined interval, from the surface that adjoins the shoe of the stator.

In addition, the protruding portion may be formed at a position spaced apart from a distal end of the insertion hole based on an axial direction at a predetermined interval in the axial direction.

In addition, the protruding portion may be provided as two or more protruding portions formed in an axial direction and spaced apart from one another at predetermined intervals in the axial direction.

In addition, the sensing terminal may include a mounting housing made of an insulating material and formed, by insert-molding, with an electrode pattern electrically connected to the eccentricity measurement sensor, and the mounting housing may include: a ring portion formed in a ring shape along a circumferential edge of the stator; a connection portion extending in a radial direction from the ring portion toward the eccentricity measurement sensor; and an external terminal into which the electrode pattern is inserted and an electrode of an external component is inserted.

In addition, the mounting housing may include a connection hole formed through a surface adjoining the eccentricity measurement sensor, the pin may be fitted into the connection hole and soldered, and the electrode pattern may electrically connect the pin and the external terminal.

In addition, the mounting housing may include a plurality of housing depressing grooves each having one surface, which adjoins an axial distal end surface of the stator, and formed concavely from one surface of the mounting housing.

In addition, the mounting housing may further include through-holes formed through the ring portion, and at least any one of the through-holes may be positioned at a position that intersects the ring portion and the connection portion or the external terminal.

In addition, the mounting housing may further include coupling portions coupled to the stator and configured to fix a position of the stator, the coupling portions may be provided one by one at two opposite circumferential sides of a bracket provided on an outer surface of the stator and surround and support the two opposite circumferential sides of the bracket, and a surface of the coupling portion, which adjoins the bracket, may include an insertion groove into which the bracket is inserted.

In addition, the mounting housing may include coil protection portions configured to adjoin surfaces of teeth of the stator, extending in the radial direction from the ring portion, and formed in shapes corresponding to spaces between motor coils and the stator.

In addition, the eccentricity measurement sensor may be provided as two or more eccentricity measurement sensors disposed in the stator, and the respective eccentricity measurement sensors may be disposed to be spaced apart from one another at equal intervals.

In addition, the eccentricity measurement sensor may be provided as two or more eccentricity measurement sensors disposed in the stator and disposed to be spaced apart from one another while having a phase difference of 90 degrees.

In addition, a method of manufacturing a motor system including the eccentricity measurement system may include: step (a) of manufacturing a sensor housing including an insertion hole and a bobbin portion and having an inserted pin; step (b) of winding a sensor coil around the bobbin portion; step (c) of joining and electrically connecting the pin and the sensor coil; and step (d) of assembling the sensor housing to the stator by fitting the shoe of the stator into the insertion hole.

### BRIEF DESCRIPTION OF THE DRAWINGS

FIG. 1 is an overall perspective view illustrating a stator to which an eccentricity measurement system of the present disclosure is applied.

FIG. 2 is an overall perspective view illustrating the eccentricity measurement system of the present disclosure.

FIG. 3 is a partial front view illustrating pins and sensor coils of an eccentricity measurement sensor of the present disclosure.

FIG. 4 is a top plan view illustrating the eccentricity measurement sensor of the present disclosure.

FIG. 5 is a cross-sectional view illustrating a stator shoe to which the eccentricity measurement sensor of the present disclosure is applied.

FIG. 6 is a partial cross-sectional view illustrating a protruding portion of the eccentricity measurement sensor of the present disclosure.

FIG. 7 is a partial front view illustrating the protruding portion of the eccentricity measurement sensor of the present disclosure.

FIG. 8 is a partial front view illustrating one embodiment of the protruding portion of the eccentricity measurement sensor of the present disclosure.

FIG. 9 is an overall perspective view of a mounting housing of the present disclosure.

FIG. 10 is a partial perspective view of the mounting housing of the present disclosure.

FIG. 11 is a partial perspective view illustrating a coupling relationship between a sensing terminal and the eccentricity measurement sensor of the present disclosure.

FIG. 12 is a partial top plan view illustrating a housing depressing groove of the present disclosure.

FIG. 13 is a partial perspective view illustrating a coupling portion of the present disclosure.

FIGS. 14 and 15 are partial perspective views illustrating coil protection portions of the present disclosure.

FIGS. 16 to 18 are schematic views illustrating embodiments of an arrangement of the eccentricity measurement sensor of the present disclosure.

FIG. 19 is a flowchart illustrating a method of manufacturing the eccentricity measurement system and a motor system including the same of the present disclosure.

FIGS. 20 and 21 are schematic views illustrating a positional relationship between a rotor and the eccentricity measurement sensor in the event of tilt eccentricity.

FIG. 22 is a schematic view illustrating a positional relationship between the rotor and the eccentricity measurement sensor in the event of static eccentricity.

FIG. 23 is a schematic view illustrating a positional relationship between the rotor and the eccentricity measurement sensor in the event of dynamic eccentricity.

FIGS. 24 and 25 are schematic views illustrating graphs of magnetic flux amounts measured by two eccentricity measurement sensors in the event of tilt eccentricity.

FIG. 26 is a schematic view illustrating graphs of the magnetic flux amounts measured by the two eccentricity measurement sensors in the event of static eccentricity.

FIG. 27 is a schematic view illustrating graphs of the magnetic flux amounts measured by the two eccentricity measurement sensors in the event of dynamic eccentricity.

### DETAILED DESCRIPTION OF THE DISCLOSURE

Hereinafter, the technical spirit of the present disclosure will be described in more detail using the accompanying drawings. In addition, terms or words used in the specification and the claims should not be interpreted as being limited to a general or dictionary meaning and should be interpreted as a meaning and a concept which conform to the technical spirit of the present disclosure based on a principle that an inventor can appropriately define a concept of a term in order to describe his/her own disclosure by the best method.

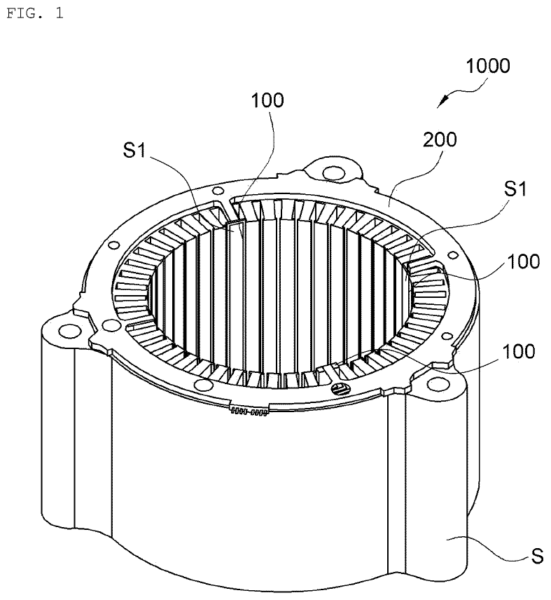

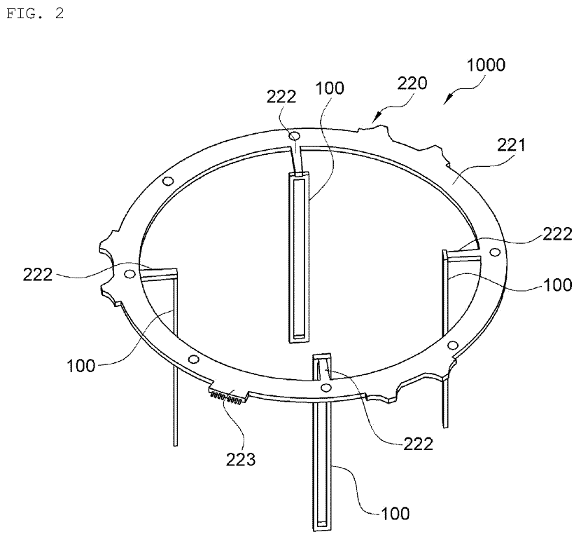

Hereinafter, a basic configuration of an eccentricity measurement system 1000 of the present disclosure will be described with reference to FIGS. 1 and 2.

The eccentricity measurement system 1000 of the present disclosure may be applied to a motor system including a stator S and a rotor R and measure eccentricity of the rotor R. As illustrated in FIGS. 1 and 2, the eccentricity measurement system 1000 may include eccentricity measurement sensors 100 and a sensing terminal 200. The eccentricity measurement sensors 100 may be fitted with shoes S1 of the stator S and measure the presence or absence of eccentricity of the rotor R by generating induced electromotive forces in sensor coils 120 by means of a change in magnetic field generated between the rotor R and the stator S. In more detail, the eccentricity measurement sensor may be a magnetic flux sensor provided such that one surface thereof faces the rotor R, and the eccentricity measurement sensor may measure a change in magnetic flux in a region including an upper end R1 and a lower end R2 of the rotor R based on an axial direction.

In addition, the sensing terminal 200 may transfer sensing information of the eccentricity measurement sensor 100 to the outside (e.g., an external device). In this case, the eccentricity measurement sensor 100, the sensing terminal 200, and a terminal assembly, which exists in advance, may be connected by soldering. In addition, the sensing terminal 200 may be formed in a ring shape along an outer periphery edge of the stator S. Therefore, motor coils C, which are wound around the sensing terminal 200 and the stator S, may not interfere with one another. Because the sensing terminal 200 is included, measurement information, which is measured by the eccentricity measurement sensor 100, may be easily transferred to the outside. Therefore, an induced electromotive force signal, which is generated by the sensor coils 120 and transmitted to the outside, may be analyzed, and the presence or absence of eccentricity of the rotor R may be identified.

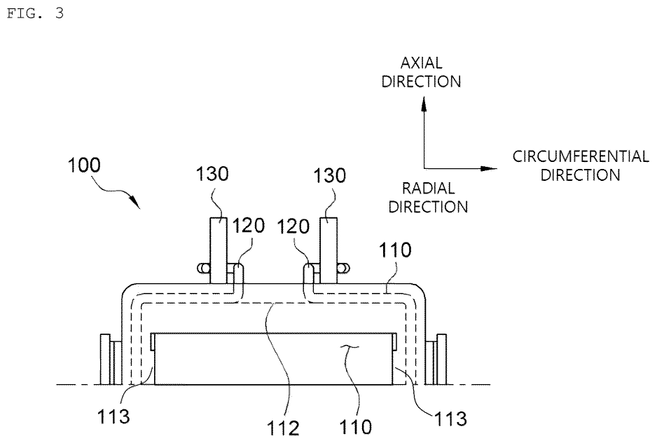

Hereinafter, the eccentricity measurement sensor 100 of the present disclosure will be described in more detail with reference to FIGS. 3 to 8.

As illustrated in FIG. 3, the eccentricity measurement sensor 100 of the present disclosure may be applied to the motor system including the stator S and the rotor R and measure eccentricity of the rotor R. The eccentricity measurement sensor 100 may be fitted with and fixed to the shoe S1 of the stator S. In more detail, the eccentricity measurement sensor 100 may include a sensor housing 110 including an insertion hole 111 penetratively formed so that the shoe S1 of the stator is fitted with the insertion hole 111. In more detail, the sensor housing 110 of the eccentricity measurement sensor 100 may be coupled to the shoe S1 of the stator in a radial direction and fitted with the shoe S1 of the stator radially inside the stator S. The insertion hole 111 may be formed in a shape identical to a shape of a surface perpendicular to the radial direction of the shoe S1 of the stator, and the sensor housing 110 may be formed in a quadrangular ring shape along an edge of the surface perpendicular to the radial direction of the shoe S1 of the stator. The eccentricity measurement sensor 100 may be inserted into a motor housing as described above, thereby minimizing interference with other components.

In addition, the eccentricity measurement sensor 100 of the present disclosure may include the sensor coils 120 and pins 130. The sensor coil 120 may be wound around the sensor housing 110, and a change in magnetic field generated between the rotor R and the stator S may generate an induced electromotive force in the sensor coil 120. In more detail, the sensor coils 120 may be disposed to extend along outer peripheries of a surface of the shoe S1 of the stator and a surface of the rotor R that face each other. Therefore, the sensor coil 120 may generate an induced current by a change in magnetic field generated in a direction perpendicular to a surface of the shoe S1 of the stator that faces a lateral surface of the rotor R, and the eccentricity measurement sensor 100 may consistently measure a change in induced electromotive force through magnetic induction by means of a change in magnetic field generated in all regions over the upper end R1 of the rotor and the lower end R2 of the rotor (based on the axial direction), thereby measuring all tilt eccentricity, static eccentricity, and dynamic eccentricity. In addition, the pins 130 may be coupled to the sensor housing 110, protrude from one surface of the sensor housing 110, be electrically connected to the sensor coil 120, and transmit a magnetic field signal of the sensor coil 120 to the outside. Therefore, an induced electromotive force signal, which is generated by the sensor coils 120 and transmitted to the outside, may be analyzed, and the presence or absence of eccentricity of the rotor R may be identified.

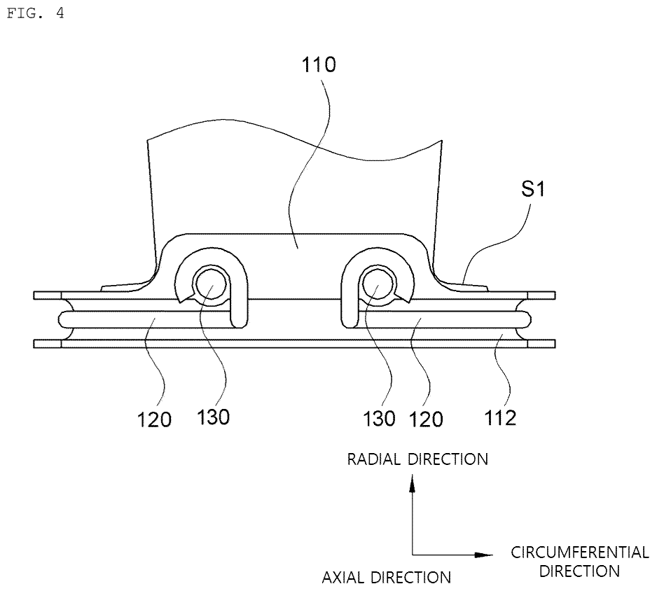

In addition, as illustrated in FIG. 4, the sensor housing 110 may include a bobbin portion 112 that is a groove concavely formed along the outer peripheries of the surface of the shoe S1 of the stator S and the surface of the rotor R that face each other, and the bobbin portion 112 has one surface that adjoins the sensor coil 120. The bobbin portion 112 may be formed such that a depth of a center based on the radial direction is deeper than a depth of an outer periphery based on the radial direction. For example, the surface, which adjoins the sensor coil 120, may be formed to be round (‘U’ shape) or formed in a ‘V’ shape. Therefore, the sensor coil 120 wound around the bobbin portion 112 may be guided to be positioned at the center of the bobbin portion 112, i.e., the center based on the radial direction. Therefore, even though the motor housing and the stator S vibrate, the sensor coil 120 is not separated, and a position of the sensor coil 120 may be constantly maintained, thereby improving accuracy in measuring eccentricity.

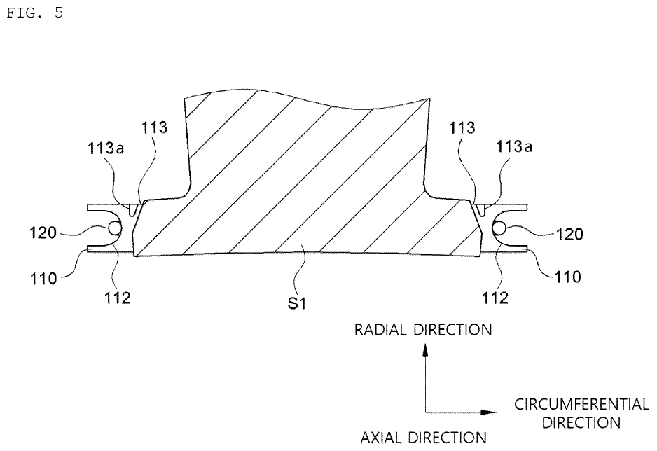

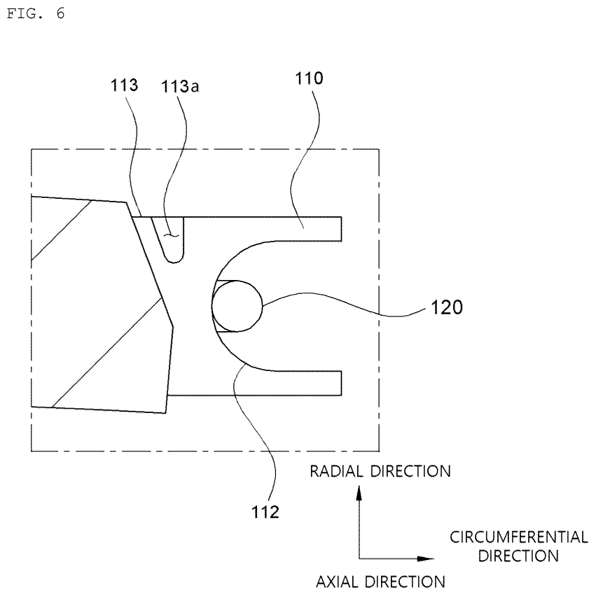

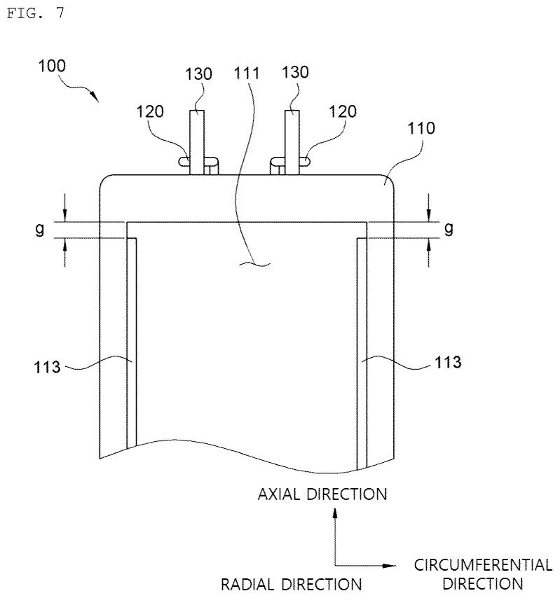

As illustrated in FIG. 5, the sensor housing 110 may include protruding portions 113 protruding from the insertion hole 111 toward the shoe S1 of the stator and having protruding surfaces that adjoin the shoe S1 of the stator. Because the protruding portion 113 is included, the eccentricity measurement sensor 100 may be fixed to a radial distal end of the shoe S1 of the stator. In this case, the protruding portions 113 may be formed at positions spaced apart from the distal end of the insertion hole 111 based on the axial direction at predetermined intervals in the axial direction. As illustrated in FIG. 5, a surface of the protruding portion, which adjoins the stator S, may be formed to be inclined at a predetermined angle without being perpendicular or parallel to a circumferential direction. That is, the surface of the protruding portion, which adjoins the stator, may be formed as an inclined surface (undercut structure). Therefore, it is possible to increase a frictional force between the protruding portion 113 and the shoe S1 of the stator and prevent the eccentricity measurement sensor 100 from separating from the shoe S1 of the stator. In addition, as illustrated in FIG. 6, the protruding portion 113 may include a sensor depressing groove 113a concavely formed at a position spaced apart inward, at a predetermined interval, from the surface that adjoins the shoe S1 of the stator. Because the sensor depressing groove 113a is included, the undercut structure, in which a surface identical to the stator S is formed to be inclined as described above, may be more smoothly formed. In this case, as illustrated in FIG. 7, the protruding portion 113 is formed at a position spaced apart, by a predetermined gap g, from the distal end of the insertion hole 111 based on the axial direction, such that the sensor depressing groove 113a and the undercut structure may be more easily processed.

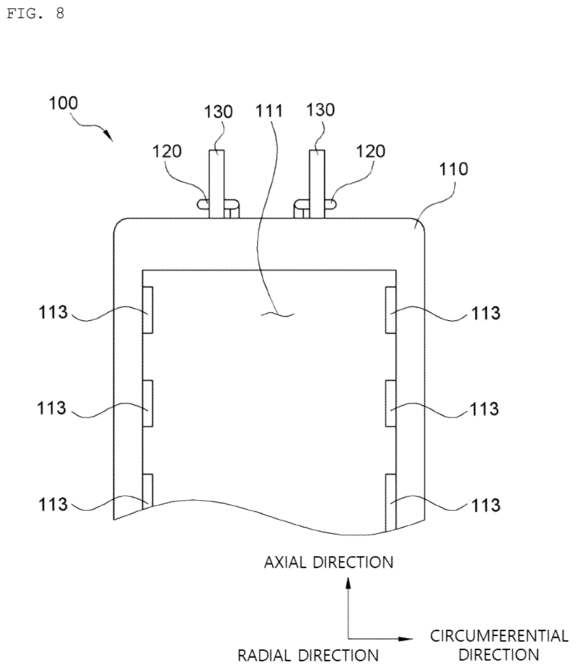

In addition, as illustrated in FIG. 8, the protruding portion 113 may be provided as two or more protruding portions 113 formed in the axial direction and spaced apart from one another at predetermined intervals in the axial direction. Therefore, it is possible to reduce an area in which the protruding portion 113 and the shoe S1 of the stator are in contact with each other. Therefore, it is possible to improve convenience during an assembling process. That is, because the protruding portion 113 is formed, coupling properties between the eccentricity measurement sensor 100 and the shoe S1 of the stator may be improved. The protruding portion 113 may be applied only to a part of a lateral surface of the insertion hole 111 instead of being applied to the entirety of the lateral surface of the insertion hole 111, thereby improving convenience during the assembling process.

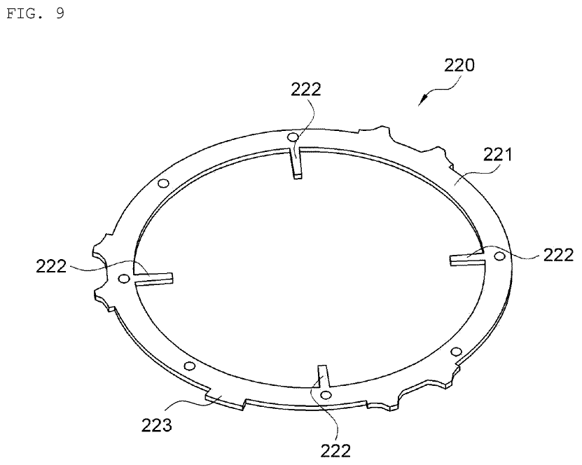

Hereinafter, the sensing terminal 200 of the present disclosure and a coupling relationship between the sensing terminal 200 and the eccentricity measurement sensor 100 will be described in more detail with reference to FIGS. 9 to 15.

As illustrated in FIG. 9, the sensing terminal 200 may include a mounting housing 220 made of an insulating material and formed with an electrode pattern 210 electrically connected to the eccentricity measurement sensor 100 and formed by insert-molding. In more detail, the mounting housing 220 may be a plastic injection-molded product. The electrode pattern 210, which is a conductor before injection-molding, may be inserted into a mold, and the mounting housing 220 may be formed together with the electrode pattern 210. The electrode pattern 210 may be manufactured by performing blanking on a copper plate by using a press. Because the mounting housing 220 is included, the electrode pattern 210 may be mounted and fixed onto the stator S. In addition, the mounting housing 220 may include a ring portion 221 formed in a ring shape along a circumferential edge of the stator S, connection portions 222 extending in the radial direction from the ring portion 221 toward the eccentricity measurement sensor 100, and an external terminal 223 into which the electrode pattern 210 is inserted and an electrode of an external component is inserted. The external terminal 223 may be formed to be withdrawn radially outward from the ring portion 221.

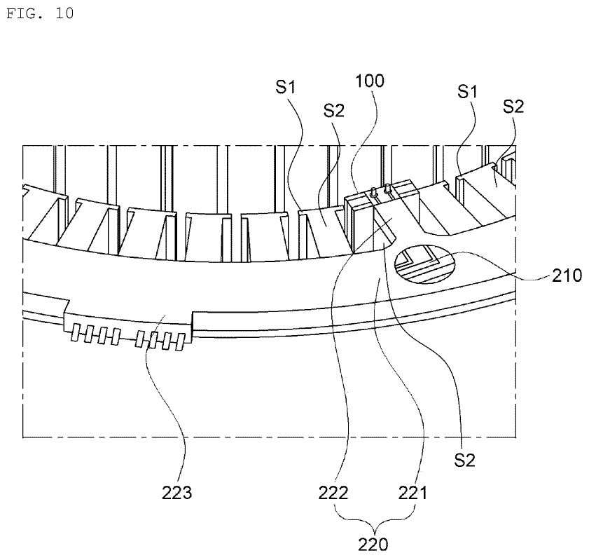

In this case, as illustrated in FIG. 10, a distal end of the electrode pattern 210 may extend to the outside of the external terminal 223. When a connector or the like is connected to the external terminal 223, the connector and the electrode pattern 210 may be electrically connected. In addition, the connection portion 222 may be connected to a tooth S2 of the stator S so that one surface thereof adjoins the tooth S2 of the stator S, such that one end of the connection portion 222 may be coupled to the eccentricity measurement sensor 100, and the other end of the connection portion 222 may be connected to the ring portion 221. In this case, one end of the connection portion 222 may adjoin the eccentricity measurement sensor 100, and a groove may be concavely formed so that the eccentricity measurement sensor 100 may be fitted into the groove.

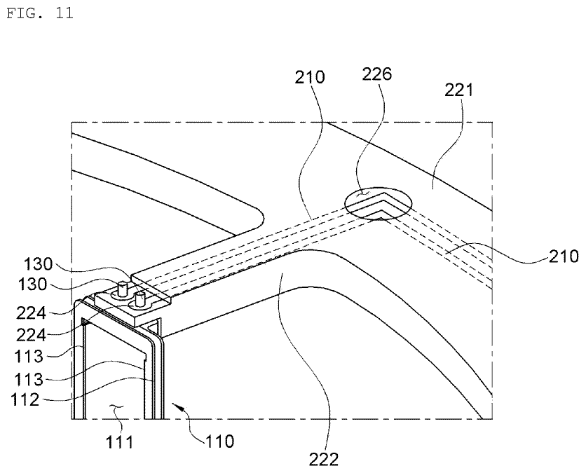

In addition, as illustrated in FIG. 11, the pins 130 of the eccentricity measurement sensor 100 may extend toward the sensing terminal 200, and the mounting housing 220 may include connection holes 224 with which the pins 130 are fitted and soldered. The connection hole 224 may be formed through a surface adjoining the eccentricity measurement sensor 100, i.e., a surface of a groove formed such that the eccentricity measurement sensor 100 is fitted into the groove. The electrode pattern 210 may extend from the connection hole 224 to which the pin 130 is soldered, and the electrode pattern 210 may electrically connect the pin 130 and the external terminal 223. Basically, the electrode pattern 210 may be provided in a state in which the electrode pattern 210 is completely inserted into the mounting housing 220. However, the electrode pattern 210 may have a shape opened outward at one side thereof in the connection hole 224 and a region adjacent to the connection hole 224. Therefore, the pin 130 and the electrode pattern 210 may be smoothly soldered.

In addition, the mounting housing 220 may further include through-holes 226 formed through the ring portion 221. At least any one of the through-holes 226 may be formed at a position that intersects the ring portion 221 and the connection portion 222 or the external terminal 223. The through-hole 226 may be a trace of a stepped portion provided in a mold and configured to support a position of the electrode pattern 210. That is, the mounting housing 220 may be manufactured by injection-molding in a state in which a stepped portion for supporting the position of the electrode pattern 210 protrudes from the mold. The reason why the stepped portion is formed at the position at which the ring portion 221 and the connection portion 222 intersect each other or the ring portion 221 and the external terminal 223 intersect each other is to more efficiently support the position of the electrode pattern 210 because the electrode pattern 210 is bent at this position. (The electrode pattern 210 extends in the circumferential direction from the ring portion 221, and the electrode pattern 210 extends in the radial direction from the connection portion 222 and the external terminal 223.)

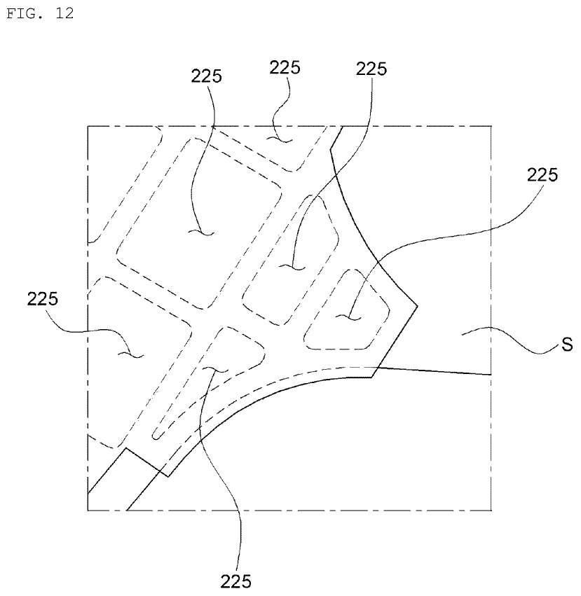

In addition, as illustrated in FIG. 12, the mounting housing 220 may include a plurality of housing depressing grooves 225 each having one surface, which adjoins an axial distal end surface of the stator S, and formed concavely from one surface of the mounting housing 220. The housing depressing grooves 225 may be formed in the entirety of one surface of the mounting housing 220. FIG. 12 is a view illustrating the housing depressing grooves 225 in a coupling portion 227 to be described below. The housing depressing grooves 225 may be formed such that one surface of the mounting housing 220 has a lattice shape. Because the housing depressing groove 225 is included, an overall weight of the sensing terminal 200 may be reduced.

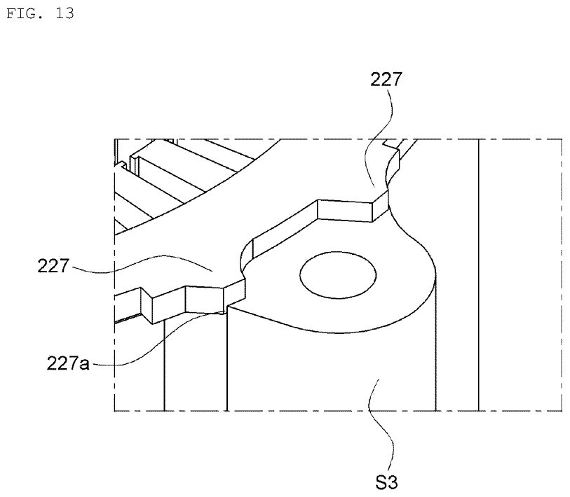

In addition, as illustrated in FIG. 13, the mounting housing 220 may further include the coupling portions 227 coupled to the stator S to fix the position of the stator S. In more detail, the coupling portions 227 may be provided one by one at two opposite circumferential sides of a bracket S3 provided on an outer surface of the stator S, and the coupling portions 227 may surround and support the two opposite circumferential sides of the bracket S3. In more detail, a surface of the coupling portions, which adjoins the bracket S3, may include an insertion groove 227a into which the bracket S3 is inserted. Any one surface of the insertion groove 227a may adjoin a surface, i.e., a lateral surface of the bracket S3 perpendicular to the radial direction of the motor, and another surface of the insertion groove 227a may adjoin a surface, i.e., a bottom surface of the bracket S3 perpendicular to an axis of the motor. Because the coupling portions 227 having the above-mentioned shapes are included, it is possible to restrict movements of the sensing terminal 200 in various directions, thereby increasing coupling strength between the stator S and the sensing terminal 200.

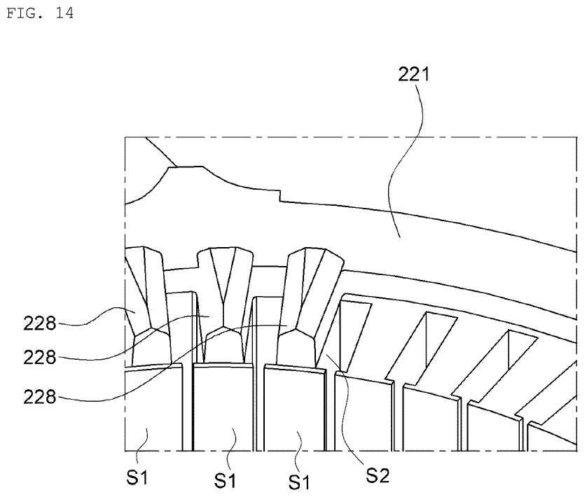

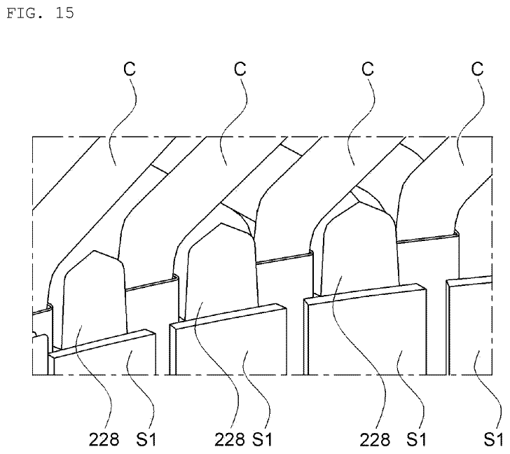

In addition, as illustrated in FIG. 14, the mounting housing 220 may include coil protection portions 228 having surfaces provided to adjoin the teeth S2 of the stator S, the coil protection portion 228 extending in the radial direction from the ring portion 221, having one surface adjoining the tooth S2 of the stator, and formed in a shape corresponding to a space between the motor coil C and the stator S. For example, an axial distal end of the coil protection portion 228 may be formed in an arcuate shape. Therefore, as illustrated in FIG. 15, the coil protection portions 228 may be positioned in the spaces between the motor coils C and the spaces between the motor coils C and the stator S and allow the motor coils C to be appropriately withdrawn along the axis of the stator S by an axial height of the coil protection portion 228. Therefore, it is possible to minimize damage to the motor coils C between the motor coils C and edges of the teeth S2 of the stator when the motor coils C are twisted for wiring.

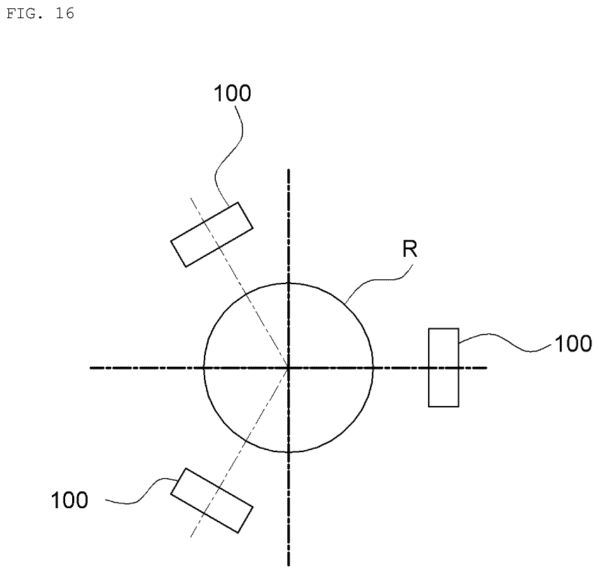

Hereinafter, embodiments of an arrangement of the eccentricity measurement sensors 100 of the present disclosure will be described in more detail with reference to FIGS. 16 to 18.

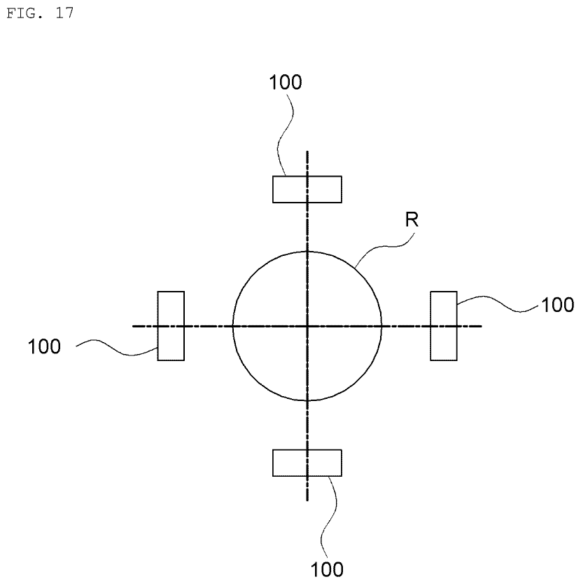

As illustrated in FIGS. 16 and 17, two or more eccentricity measurement sensors 100 may be disposed in the stator S, and the respective eccentricity measurement sensors 100 may be disposed to be spaced apart from one another at equal intervals. Because two or more eccentricity measurement sensors 100 are applied, the eccentric state may be identified by comparing data between the sensors in case that it is difficult to identify reference data when no eccentricity is present. In more detail, as illustrated in FIG. 16, in case that three eccentricity measurement sensors 100 are applied, the eccentricity measurement sensors 100 may be positioned at positions with a phase difference of 120 degrees based on the stator S and the rotation axis of the rotor R. Alternatively, as illustrated in FIG. 17, in case that four eccentricity measurement sensors 100 are applied, the eccentricity measurement sensors 100 may be positioned at positions with a phase difference of 90 degrees based on the stator S and the rotation axis of the rotor R. Likewise, in case that two eccentricity measurement sensors 100 are applied, the eccentricity measurement sensors 100 may be positioned at positions with a phase difference of 180 degrees based on the stator S and the rotation axis of the rotor R.

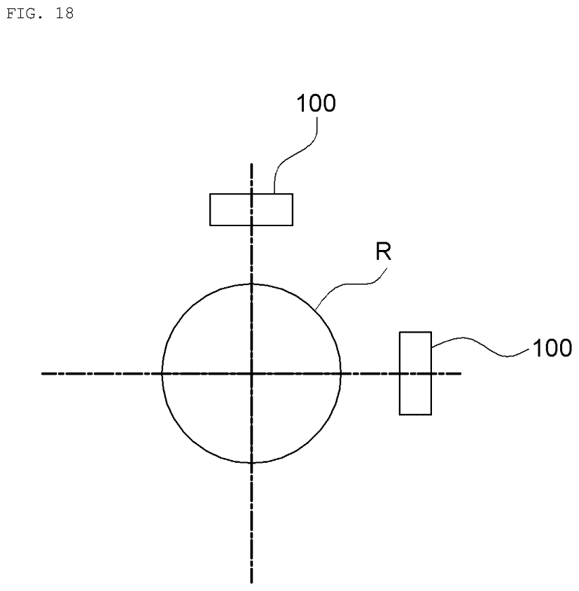

In addition, as illustrated in FIG. 18, two or more eccentricity measurement sensors 100 may be disposed in the stator S and disposed to be spaced apart from one another while having a phase difference of 90 degrees. Therefore, the eccentric state may be identified by comparing data between the sensors in case that it is difficult to identify the reference data when no eccentricity is present.

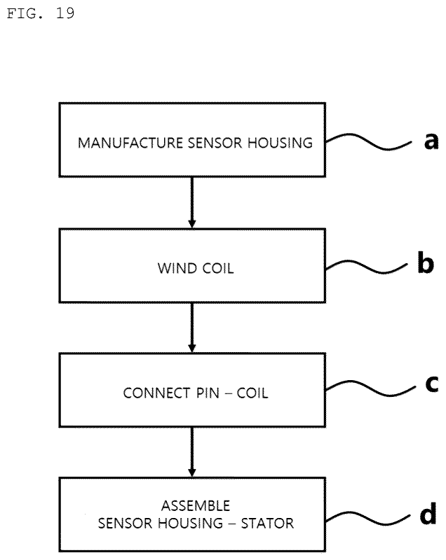

Hereinafter, a method of manufacturing the motor system including the eccentricity measurement sensor 100 of the present disclosure will be described in more detail with reference to FIG. 19.

As illustrated in FIG. 19, the method of manufacturing the motor system including the eccentricity measurement sensor 100 of the present disclosure may include step (a) of manufacturing the sensor housing 110 including the insertion hole 111 and the bobbin portion 112 and having the inserted pin 130, step (b) of winding the sensor coil 120 around the bobbin portion 112, step (c) of joining and electrically connecting the pin 130 and the sensor coil 120, and step (d) of assembling the sensor housing 110 to the stator S by fitting the shoe S1 of the stator into the insertion hole 111.

In more detail, in step (a), the sensor housing 110 may be formed by injection-molding, and the insert-injection molding may be formed in a state in which the pin 130 is inserted into a mold. The pin 130 may be inserted into a surface provided to the surface of the sensor housing 110 in which the insertion hole 111 is formed. In addition, the pin 130 may be basically made of copper having conductivity and adopt a type of copper alloy because strength and rigidity are required for winding or subsequent external wiring. The pin 130 may have a cylindrical shape so that the sensor coil 120 may be easily wound around or fixed to the pin 130. However, in case that the sensor coil 120 is an angular coil, the sensor coil 120 may have an angular shape to ensure ease of joining.

In addition, in step (b), the sensor coil 120 may be wound around a groove formed in the bobbin portion 112. The sensor coil 120 may be a magnet wire having a surface having an insulating coating. The sensor coil 120 may be a round wire or an angular wire. In addition, in step (c), the sensor coil 120 may be wound around and fixed to an outer peripheral surface of the pin 130. The sensor coil 120 may be a self-fusing coil. Therefore, the sensor coil 120 may be more easily fixed to the pin 130. Alternatively, the sensor coil 120 and the pin 130 may be joined to each other by soldering, arc welding, ultrasonic welding, resistance welding, or the like.

In addition, in step (d), the eccentricity measurement sensor 100 may be fixed to the tooth of the stator S in the radial direction at an inner diameter position of a core of the stator S. Thereafter, the stator S and the eccentricity measurement sensor 100 may be fixed by using an impregnation liquid when the stator S is impregnated. In this case, the impregnation liquid may be allowed to flow to the bobbin portion 112 of the eccentricity measurement sensor 100, such that the sensor coil 120 wound around the bobbin portion 112 may also be simultaneously fixed. Therefore, the eccentricity measurement sensor 100 may be moved toward an outer diameter portion and completely prevented from being separated from the shoe S1 of the stator, thereby improving accuracy in measuring eccentricity.

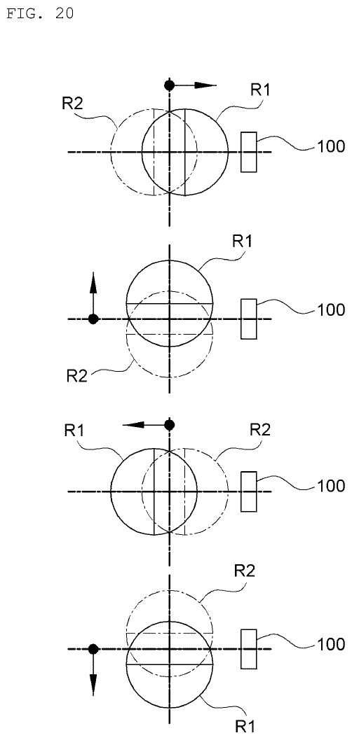

Hereinafter, an algorithm for measuring the eccentricity of the rotor R by using the eccentricity measurement sensor 100 of the present disclosure will be described with reference to FIGS. 20 to 27.

As illustrated in FIG. 20, in case that one eccentricity measurement sensor 100 is applied and the upper end R1 and the lower end R2 of the rotor are inclined to the same degree in opposite (radial) directions (tilt eccentricity case 1), the magnetic flux amount at the side close to the eccentricity measurement sensor 100 may increase, and the magnetic flux amount at the side distant from the eccentricity measurement sensor 100 may decrease. That is, the overall magnetic flux amount may change.

In more detail, in case that eccentricity occurs in a leftward/rightward direction in FIG. 20, an aspect may be measured in which the magnetic flux amount only at any one of the upper end R1 or the lower end R2 of the rotor R increases, and the magnetic flux amount at the other of the upper end R1 or the lower end R2 of the rotor R decreases. That is, it can be ascertained that in case that the magnetic flux amount at the upper end R1 of the rotor increases and the magnetic flux amount at the lower end R2 of the rotor decreases, the upper end R1 of the rotor is inclined toward the eccentricity measurement sensor 100. In the opposite case, it can be ascertained that the lower end R2 of the rotor is inclined toward the eccentricity measurement sensor 100.

In addition, in case that eccentricity occurs in an upward/downward direction in FIG. 20, both the upper end R1 and the lower end R2 of the rotor R are distant from the eccentricity measurement sensor 100, such that the magnetic flux amounts may decrease at both the upper end R1 and the lower end R2 of the rotor R. Therefore, it can be ascertained that the eccentricity occurs in a direction perpendicular to the direction in which the rotor R faces the eccentricity measurement sensor 100.

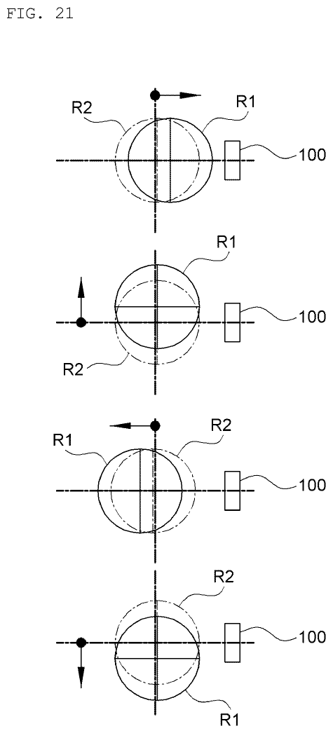

As illustrated in FIG. 21, in case that one eccentricity measurement sensor 100 is applied and only any one of the upper end R1 and the lower end R2 of the rotor R is inclined (tilt eccentricity case 2), the inclined side of the rotor R becomes close to or distant from the eccentricity measurement sensor 100, such that the magnetic flux amount may increase or decrease.

In more detail, in case that eccentricity occurs, an aspect may be measured in which the magnetic flux amount only at any one of the upper end R1 or the lower end R2 of the rotor R increases or decreases, and the magnetic flux amount at the other of the upper end R1 or the lower end R2 of the rotor R is maintained. That is, it can be ascertained that in case that the magnetic flux amount at the upper end R1 of the rotor increases or decreases and the magnetic flux amount at the lower end R2 of the rotor is maintained, the upper end R1 of the rotor is inclined. In the opposite case, it can be ascertained that the lower end R2 of the rotor is inclined.

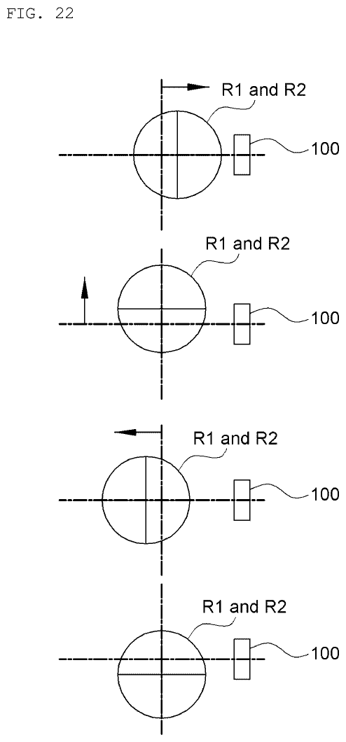

As illustrated in FIG. 22, in case that one eccentricity measurement sensor 100 is applied and both the upper end R1 and the lower end R2 of the rotor R are constantly eccentric, i.e., in case that the rotor R is eccentric in the radial direction (static eccentricity), both the upper end R1 and the lower end R2 of the rotor R become close to or distant from the eccentricity measurement sensor 100 in the same way, such that the magnetic flux amount may increase or decrease. That is, it can be ascertained that the rotor R is statically eccentric toward the eccentricity measurement sensor 100 when the magnetic flux amounts at the upper end R1 and the lower end R2 of the rotor simultaneously increase in the same way, and the rotor R is statically eccentric in a direction away from the eccentricity measurement sensor 100 when the magnetic flux amounts at the upper end R1 and the lower end R2 of the rotor simultaneously decrease in the same way.

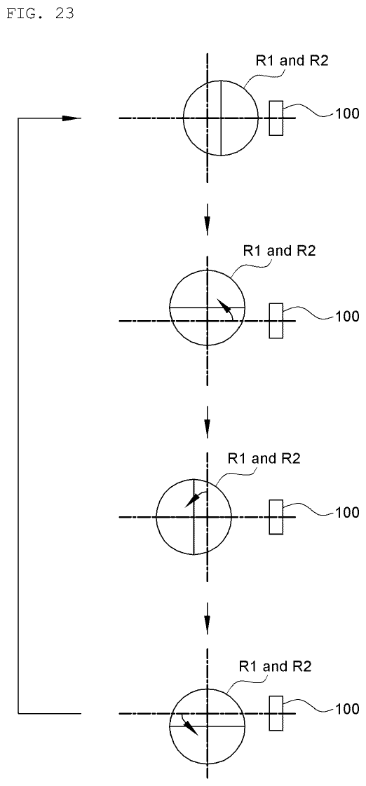

In addition, as illustrated in FIG. 23, in case that one eccentricity measurement sensor 100 is applied and a value of an air gap changes over time (dynamic eccentricity), the magnetic flux amount measured from the rotor R may change over time, and the cycle of the magnetic flux amount may also change. In more detail, when the rotor R becomes close to the eccentricity measurement sensor 100, the magnetic flux amount may increase at the same time when the cycle of the magnetic flux amount is shortened. When the rotor R becomes distant from the eccentricity measurement sensor 100 in the opposite direction, the magnetic flux amount may decrease at the same time when the cycle of the magnetic flux amount is lengthened.

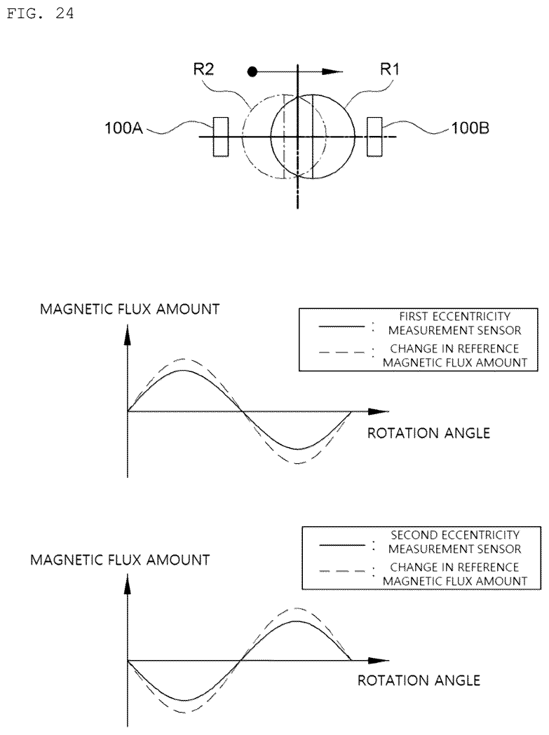

In addition, as illustrated in FIG. 24, in case that two eccentricity measurement sensors 100 are applied and the upper and lower sides of the rotor R are inclined to the same degree in opposite (radial) directions (tilt eccentricity case 1), the magnetic flux amount close at the side to the eccentricity measurement sensor 100 may increase, and the magnetic flux amount at the side distant from the eccentricity measurement sensor 100 may decrease. That is, the overall magnetic flux amount may change.

For example, in case that a first eccentricity measurement sensor 100A and a second eccentricity measurement sensor 100B are disposed to be spaced apart from each other with a phase difference of 180 degrees and the tilt eccentricity of the rotor R occurs at the first eccentricity measurement sensor 100A and the second eccentricity measurement sensor 100B, the magnetic flux amount may partially decrease in comparison with a reference magnetic flux amount determined when no eccentricity occurs at both the first eccentricity measurement sensor 100A and

### The Second Eccentricity Measurement Sensor 100b. This

represents an aspect in which the magnetic flux amount decreases as the upper end R1 or the lower end R2 of the rotor R becomes distant from the first eccentricity measurement sensor 100A and the second eccentricity measurement sensor 100B.

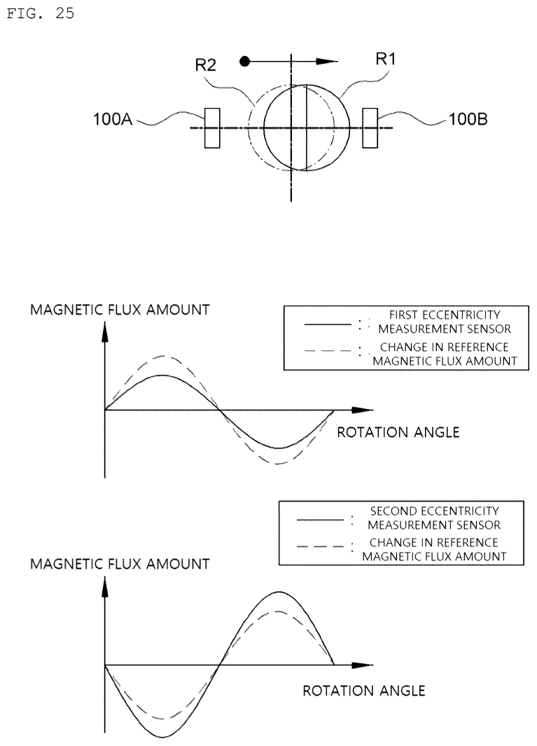

In addition, as illustrated in FIG. 25, in case that two eccentricity measurement sensors 100 are applied and only any one of the upper end R1 and the lower end R2 of the rotor R is inclined (tilt eccentricity case 2), the magnetic flux amount at the side close to the eccentricity measurement sensor 100 may increase, the magnetic flux amount at the side distant from the eccentricity measurement sensor 100 may decrease, and the magnetic flux amount at another side may be maintained. For example, in case that the first eccentricity measurement sensor 100A and the second eccentricity measurement sensor 100B are disposed to be spaced apart from each other with a phase difference of 180 degrees and the eccentricity of the upper end R1 of the rotor occurs so that the upper end R1 of the rotor becomes close to the second eccentricity measurement sensor 100B, the magnetic flux amount at the first eccentricity measurement sensor 100A may become partially smaller than a reference value, and the magnetic flux amount at the second eccentricity measurement sensor 100B may become partially larger than the reference value.

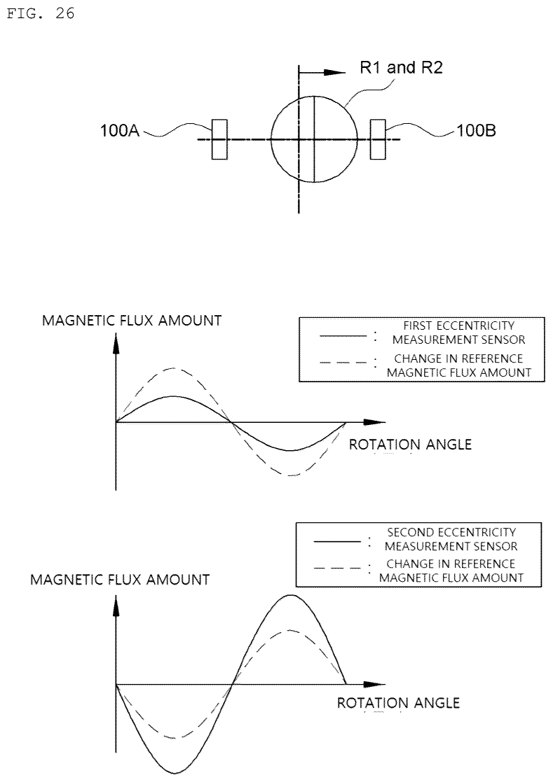

In addition, as illustrated in FIG. 26, in case that two eccentricity measurement sensors 100 are applied and both the upper end R1 and the lower end R2 of the rotor R are constantly eccentric, i.e., in case that the rotor R is eccentric in the radial direction (static eccentricity), both the upper end R1 and the lower end R2 of the rotor R become close to or distant from the eccentricity measurement sensor in the same way, such that the magnetic flux amount may increase or decrease. That is, the magnetic flux amounts at the upper end R1 and the lower end R2 of the rotor may simultaneously increase in the same way. For example, in case that the first eccentricity measurement sensor 100A and the second eccentricity measurement sensor 100B are disposed to be spaced apart from each other with a phase difference of 180 degrees and the eccentricity of the rotor occurs so that the rotor becomes close to the second eccentricity measurement sensor 100B, the magnetic flux amount at the first eccentricity measurement sensor 100A may become significantly smaller than a reference value, and the magnetic flux amount at the second eccentricity measurement sensor 100B may become significantly larger than the reference value.

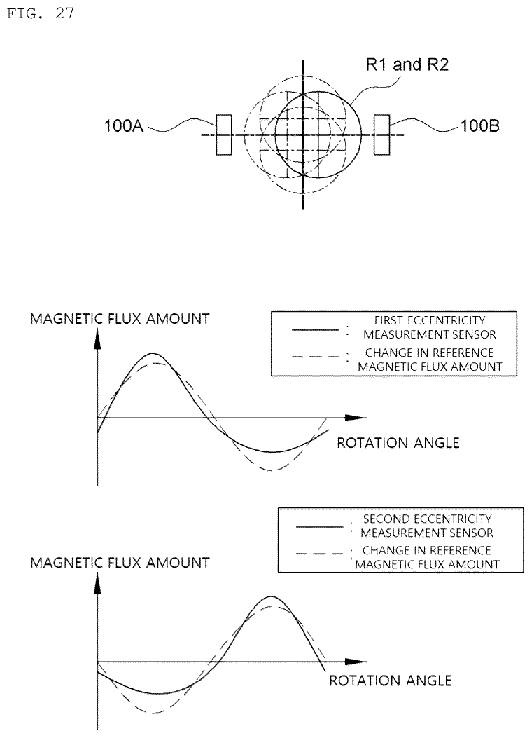

In addition, as illustrated in FIG. 27, in case that two eccentricity measurement sensors 100 are applied and a value of an air gap changes over time (dynamic eccentricity), the magnetic flux amount measured from the rotor R may change over time, and both the rotation angle and the magnetic flux amount may change over time. For example, in case that the first eccentricity measurement sensor 100A and the second eccentricity measurement sensor 100B are disposed to be spaced apart from each other with a phase difference of 180 degrees and dynamic eccentricity occurs in the rotor R, the magnetic flux amount graphs of the first eccentricity measurement sensor 100A and the second eccentricity measurement sensor 100B may be formed in opposite directions and different in magnetic flux amount and cycle from the reference value.

Furthermore, at least two or more of the tilt eccentricity, the static eccentricity, and the dynamic eccentricity may occur while overlapping one another. In this case, the type of eccentricity may be analyzed by comparing each of the eccentricity data with the measured data.

According to the eccentricity measurement sensor and the method of manufacturing the motor system including the same of the present disclosure configured as described above, the eccentricity measurement system may include the eccentricity measurement sensor mounted in the motor and configured to measure all the tilt eccentricity, the static eccentricity, and the dynamic eccentricity of the rotor by using a change in magnetic field generated between the rotor and the stator, thereby overcoming a limitation of a reflective laser sensor method in the related art, reducing costs in comparison with the reflective laser sensor in the related art, detecting the eccentricity factor that most significantly affects noise and vibration of the rotary device, detecting a defect at the initial stage of mass production to prevent shipment of potentially defective products, measuring eccentricity caused by abrasion or the like after product durability testing or after prolonged operation of the vehicle to detect in advance a problem, and taking in advance an action such as repair.

In addition, with the above-described eccentricity measurement system, when the eccentricity measurement system is applied to the autonomous vehicles in the future, it is possible to monitor a mechanical state of the rotary device, apply the eccentricity measurement system to a smart rotary device system capable of evaluating a state thereof by using the pre-secured defect level index, and recognize the state of the rotary device in a region imperceptible to humans. Furthermore, the eccentricity measurement system may be applied in a case in which it is difficult to recognize a state of the individual rotary device because of external vibration or noise, such that the eccentricity measurement system may be used to detect and address problems in the electric motor used in urban air mobility (UAM) aircraft in advance.

The technical spirit should not be construed as being limited to the embodiments of the present disclosure. Of course, the scope of application is diverse, and various modifications and implementations may be made by those skilled in the art without departing from the subject matter of the present disclosure claimed in the claims. Accordingly, these improvements and modifications will fall within the scope of the present disclosure as long as they are apparent to those skilled in the art.

What is claimed is:

1. An eccentricity measurement system, which is applied to a motor system comprising a stator and a rotor and measures eccentricity of the rotor, the eccentricity measurement system comprising:
an eccentricity measurement sensor fitted with a shoe of the stator and configured to measure a presence or absence of eccentricity of the rotor by measuring a change in magnetic field generated between the rotor and the stator; and
a sensing terminal configured to transfer sensing information of the eccentricity measurement sensor to an external device,
wherein an electrode pattern electrically connected to the eccentricity measurement sensor is inserted into the sensing terminal.

2. The eccentricity measurement system of claim 1, wherein the eccentricity measurement sensor comprises:
a sensor housing comprising an insertion hole formed through the sensor housing so that the shoe of the stator is fitted into the insertion hole;
a sensor coil wound around the sensor housing, disposed to extend along outer peripheries of a surface of the shoe of the stator and a surface of the rotor facing each other, and configured to measure a change in magnetic field generated between the rotor and the stator; and
a pin coupled to the sensor housing, protruding from one surface of the sensor housing, electrically connected to the sensor coil, and configured to transmit a magnetic field signal of the sensor coil to the outside.

3. The eccentricity measurement system of claim 2, wherein the sensor housing comprises a bobbin portion that is a groove concavely formed along the outer peripheries of the surface of the shoe of the stator and the surface of the rotor that face each other, the bobbin portion having one surface that adjoins the sensor coil,
wherein one surface of the bobbin portion, which adjoins the sensor coil, is formed to be round, and
wherein the bobbin portion is formed such that a depth of a center based on a radial direction is deeper than a depth of an outer periphery based on the radial direction.

4. The eccentricity measurement system of claim 3, wherein the sensor housing comprises a protruding portion protruding from the insertion hole toward the shoe of the stator and having a protruding surface that adjoins the shoe of the stator.

5. The eccentricity measurement system of claim 4, wherein a surface of the protruding portion, which adjoins the stator, is formed to be inclined at a predetermined angle without being perpendicular or parallel to a circumferential direction.

6. The eccentricity measurement system of claim 5, wherein the protruding portion comprises a sensor depressing groove concavely disposed at a position spaced apart inward, at a predetermined interval, from the surface that adjoins the shoe of the stator.

7. The eccentricity measurement system of claim 6, wherein the protruding portion is disposed at a position spaced apart from a distal end of the insertion hole based on an axial direction at a predetermined interval in the axial direction.

8. The eccentricity measurement system of claim 4, wherein the protruding portion is provided as two or more protruding portions disposed in an axial direction and spaced apart from one another at predetermined intervals in the axial direction.

9. The eccentricity measurement system of claim 2, wherein the sensing terminal comprises a mounting housing made of an insulating material and formed, by insert-molding, with an electrode pattern electrically connected to the eccentricity measurement sensor, and
wherein the mounting housing comprises:
a ring portion formed in a ring shape along a circumferential edge of the stator;
a connection portion extending in a radial direction from the ring portion toward the eccentricity measurement sensor; and
an external terminal into which the electrode pattern is inserted and an electrode of an external component is inserted.

10. The eccentricity measurement system of claim 9, wherein the mounting housing comprises a connection hole formed through a surface adjoining the eccentricity measurement sensor,
wherein the pin is fitted into the connection hole and soldered, and
wherein the electrode pattern electrically connects the pin and the external terminal.

11. The eccentricity measurement system of claim 9, wherein the mounting housing comprises a plurality of housing depressing grooves each having one surface, which adjoins an axial distal end surface of the stator, and formed concavely from one surface of the mounting housing.

12. The eccentricity measurement system of claim 9, wherein the mounting housing further comprises through-holes formed through the ring portion, and
wherein at least any one of the through-holes is positioned at a position that intersects the ring portion and the connection portion or the external terminal.

13. The eccentricity measurement system of claim 9, wherein the mounting housing further comprises coupling portions coupled to the stator and configured to fix a position of the stator,
wherein the coupling portions are provided one by one at two opposite circumferential sides of a bracket provided on an outer surface of the stator and surround and support the two opposite circumferential sides of the bracket, and
wherein a surface of the coupling portions, which adjoins the bracket, comprises an insertion groove into which the bracket is inserted.

14. The eccentricity measurement system of claim 9, wherein the mounting housing comprises coil protection portions configured to adjoin surfaces of teeth of the stator, extending in the radial direction from the ring portion, and formed in shapes corresponding to spaces between motor coils and the stator.

15. The eccentricity measurement system of claim 1, wherein the eccentricity measurement sensor is provided as two or more eccentricity measurement sensors disposed in the stator, and the eccentricity measurement sensors are disposed to be spaced apart at equal intervals from one another.

16. The eccentricity measurement system of claim 1, wherein the eccentricity measurement sensor is provided as two or more eccentricity measurement sensors disposed in the stator and disposed to be spaced apart from one another while having a phase difference of 90 degrees.

17. A method of manufacturing a motor system comprising the eccentricity measurement system of claim 1, the method comprising:
manufacturing a sensor housing comprising an insertion hole and a bobbin portion and having an inserted pin;
winding a sensor coil around the bobbin portion;
joining and electrically connecting the pin and the sensor coil; and
assembling the sensor housing to the stator by fitting the shoe of the stator into the insertion hole.
